(19) United States
(12) Patent Application Publication
(10) Pub. No.: US 2025/0081994 A1
(43) Pub. Date: Mar. 13, 2025

(54) PROCESS AND DEVICE FOR MANUFACTURING EDIBLE AND/OR BIODEGRADABLE ARTICLES

(71) Applicant: Agustín Vierheller, Buenos Aires (AR)

(72) Inventor: Agustín Vierheller, Buenos Aires (AR)

(21) Appl. No.: 18/955,758

(22) Filed: Nov. 21, 2024

Related U.S. Application Data
(63) Continuation of application No. 17/595,291, filed on Nov. 12, 2021, now abandoned.

(30) Foreign Application Priority Data
May 13, 2019 (AR) P20190101275
Dec. 30, 2019 (AR) P20190103915

(51) Int. Cl. A23L 7/10; A23L 5/10; A47G 21/00

(52) U.S. Cl. CPC A23L 7/10; A23L 5/15; A47G 21/00; A23V 2002/00

(57) ABSTRACT

A process for manufacturing edible and/or biodegradable articles, including: providing a mixture including from about 20% by weight to about 60% by weight of rice flour, up to about 2% by weight of at least one thickening agent selected from the group consisting of guar gum and derivatives of guar gum, from about 1% by weight to about 20% by weight of refined powdered cellulose, and from about 20% to about 80% by weight of water; placing the mixture in a mold; and cooking the mixture in the mold when the mold is closed, wherein pressure generated within the closed mold is released one or more times during said cooking to allow exhaust of a vapor generated inside the mold.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to processes and devices for manufacturing edible and/or biodegradable articles. The present disclosure also relates to the edible and/or biodegradable articles manufactured by said processes and/or using said devices. More particularly, the disclosure relates to processes and devices for manufacturing edible and/or biodegradable articles that may be, for example, kitchen utensils, tableware and/or household articles or utensils, for example, knives, forks, spoons, stirrers, chopsticks, skewers, sticks, straws, popsicle sticks, cones, ice cream cornets, packaging and containers of all kinds with or without a lid such as cups, mugs, demitasses, plates, dessert bowls, trays, bowls, salad bowls, and the like. Also contemplated within the present disclosure are edible and/or biodegradable articles that may be used as sports equipment.

### BACKGROUND

There are countless kitchen utensils, tableware, household and sports articles, among others, used in daily life that are usually manufactured from materials that are not readily biodegradable or edible, such as plastic or metal. The disposal of these products has a negative impact on the environment because they have an extended degradation period in environmental conditions, which would generally degrade other materials in a quicker and more environmentally-friendly manner.

Instruments and tools normally used for eating are mainly related to history and tradition, i.e., the culture of the community using them. For example, chopsticks, which consist of a pair of straight sticks of similar length, used traditionally as eating utensils in China, Japan, North Korea, South Korea and Vietnam, as well as in Thailand, are an example of these tools. Chopsticks have a simple design; traditionally they are two thin sticks, generally one slightly shorter than the other, where the surface area at the ends is less than one square centimeter, with varying lengths. The smaller ends are meant to be contacted with the food. Chopsticks are usually made of wood, bamboo, metal, bone, ivory, and currently also plastic. A similar situation to the above described for chopsticks applies to countless kitchen, tableware and household articles that are widely used, especially for eating or for drinking infusions. Particular examples are knives, forks, spoons, packaging of all kinds, stirrers, skewers, rods, popsicle sticks, and the like. Usually, these articles or utensils are made of plastic, metal, wood, or a combination of these materials, also generating a negative environmental impact when disposed of. The use of wood has the additional negative environmental impact of logging.

In sports, many disposable articles are used, which are rarely manufactured from biodegradable materials, and even less from edible materials. For example, golf tees are usually also made of plastic and produce harmful effects on the environment when disposed of.

Therefore, the materials normally used for manufacturing these kitchen, tableware, household or even sports articles are not biodegradable, or they degrade over extremely long periods of time. Since generally these articles are also disposable, it becomes necessary to minimize the environmental impact generated by articles that are disposed after use and that are not readily biodegradable. Thus, there is an important need for kitchen utensils, tableware, household or sports articles that are disposable and biodegradable over short periods of time, either by being edible or by natural decomposition.

Although a number of edible articles or utensils are available in the market, in many cases the fragility of these products discourages their use, because they break easily. Moreover, several known edible articles or utensils soften easily upon contact with liquid or semi-liquid substances, such as liquid foods, drinks or water, rendering their use inappropriate for these substances. There is therefore an additional need for kitchen utensils, tableware, household or sports articles that are edible and/or biodegradable, and that also have a suitable hardness to be less prone to break when used, and/or to prevent softening upon contact with liquid or semi-liquid substances, or products with high water content.

### SUMMARY

In a first aspect, the present disclosure relates to a process for manufacturing edible and/or biodegradable articles comprising the steps of:
providing a mixture comprising flour made from one or more cereals and/or pseudocereals, insoluble fibers, at least one thickening agent and an aqueous liquid;
placing the mixture in a mold; and
cooking the mixture in the closed mold, where the pressure generated within the mold is released one or more times during cooking process to allow exhaust of the vapor generated inside the mold.

In a process according to an embodiment of the present disclosure, the at least one thickening agent is selected from the group consisting of natural or synthetic hydrophilic gums, galactomannans and their derivatives, such as hydroxyalkyl galactomannans, carboxyalkyl galactomannans, hydroxyalkyl carboxyalkyl galactomannans, or gums comprising galactomannans or their derivatives, for example, guar gum, derivatives of guar gum, hydroxypropyl guar gum, hydroxyethyl guar gum, hydroxyethyl carboxymethyl guar gum, carboxymethyl guar gum, carboxymethylhydroxypropyl guar gum, carboxyethyhydroxypropyl guar gum, carob gum, tara gum, arabic gum, tragacanth gum, karaya gum, alginate, xanthan gum, gellan gum, pullulan, konjac, brea gum (exudate from Parkinsonia praecox), fenugreek gum, cassia gum, flour made from Cyamopsis tetragonoloba seeds, and derivatives and combinations thereof.

In a process according to an embodiment of the present disclosure, the insoluble fibers are selected from the group consisting of cellulose or hemicellulose fibers, resistant starch, powdered cellulose, refined powdered cellulose grade 30, 75, 90, 200 or 500 micrometers, microcrystalline cellulose, fiber from ground cereals, ground linseed, ground chia seeds, ground quinoa seeds, ground buckwheat seeds, wheat fiber, rice fiber, carrot fiber, citric fiber, potato fiber, corn fiber, banana fiber, blueberry fiber, apple fiber, bamboo fiber, coconut fiber, sugar cane fiber, oat fiber, pea fiber and derivatives and combinations thereof.

In a process according to an embodiment of the present disclosure, the flour made from one or more cereals and/or pseudocereals is selected from the group consisting of rice flour, oat flour, barley flour, rye flour, corn flour, millet flour, wheat flour, sorghum flour, spelt flour, amaranth (kiwicha, huautli, Amaranthus hypochondriacus, celosia) flour, quinoa flour, chia (chan) flour, breadnut (Brosimum alicastrum) flour, buckwheat flour, cattail (typha) flour, canihua (kañiwa) flour, acacia flour, huauzontle (Chenopodium berlandieri) flour and combinations thereof.

In a second aspect, the present disclosure relates to an edible and/or biodegradable article manufactured by the process of the present disclosure. The edible and/or biodegradable article manufactured by the process according to an embodiment of the present disclosure may be a kitchen utensil, tableware and/or household article or utensil, for example, knives, forks, spoons, stirrers, chopsticks, skewers, rods, straws, popsicle sticks, cones, ice cream cornets, packaging and containers of all kinds with or without a lid such as cups, mugs, demitasses, plates, dessert bowls, trays, bowls, salad bowls, and the like. In another embodiment, the edible and/or biodegradable article may be a sports article, for example, a golf tee.

In a third aspect, the present disclosure relates to a device for manufacturing edible and/or biodegradable articles comprising:
a lower support element and an upper support element, where the lower support element comprises a bottom mold piece and where the upper support element comprises a top mold piece, where each of said pieces of said mold comprises an inner surface, where the inner surface of at least one of the two mold pieces comprises at least one hollow portion, so that, when faced to each other and placed in contact, said inner surfaces of said two mold pieces form at least one cavity capable of containing a mixture of ingredients of the edible and/or biodegradable article to be manufactured; where the mold pieces are capable of withstanding cooking temperatures;
a frame structure serving as a support base, stand or rack for the other parts of the device,
being said bottom and upper support elements placed so that at least one of said bottom or upper support elements can be moved, allowing the inner surfaces of the mold pieces to approach or move away from each other, so that the mold may change from an open position to a closed position and vice versa; where, in said closed position, when the inner surfaces of the mold pieces are facing each other and in contact, form said at least one cavity; and where, in said open position, when the inner surfaces of the mold pieces are separated, the cavity is open;
mechanical means to move at least one of said top or bottom support elements; and
heating means to heat the mold pieces.

### BRIEF DESCRIPTION OF THE DRAWINGS

FIG. 1 represents a device according to an embodiment of the present disclosure.

FIG. 2 represents a perspective view of a device according to an embodiment of the present disclosure.

FIG. 3 represents a perspective view of a device according to an embodiment of the present disclosure comprising a mold filling mechanism.

FIG. 4 represents a side view of a device according to an embodiment of the present disclosure comprising a mold filling mechanism.

FIG. 5 represents a perspective view of two devices according to an embodiment of the present disclosure placed side by side next to a conveyor belt.

FIG. 6 represents a perspective view of several devices according to an embodiment of the present disclosure placed side by side next to a conveyor belt.

FIG. 7 represents a perspective view of a mold piece that may be used in a device according to an embodiment of the present disclosure.

### DETAILED DESCRIPTION

In a first aspect, the present disclosure relates to a process for manufacturing edible and/or biodegradable articles comprising the steps of:
providing a mixture comprising flour made from one or more cereals and/or pseudocereals, insoluble fibers, at least one thickening agent and an aqueous liquid;
placing the mixture in a mold; and
cooking the mixture in the closed mold, where the pressure generated within the closed mold is released one or more times during cooking to allow exhaust of the vapor generated inside the mold.

In a process according to an embodiment of the present disclosure, the at least one thickening agent is selected from the group consisting of natural or synthetic hydrophilic gums, galactomannans and their derivatives, such as hydroxyalkyl galactomannans, carboxyalkyl galactomannans, hydroxyalkyl carboxyalkyl galactomannans, or gums comprising galactomannans or their derivatives, for example, guar gum, derivatives of guar gum, hydroxypropyl guar gum, hydroxyethyl guar gum, hydroxyethyl carboxymethyl guar gum, carboxymethyl guar gum, carboxymethylhydroxypropyl guar gum, carboxyethylhydroxypropyl guar gum, carob gum, tara gum, arabic gum, tragacanth gum, karaya gum, alginate, xanthan gum, gellan gum, pullulan, konjac, brea gum (exudate from Parkinsonia praecox), fenugreek gum, cassia gum, flour made from Cyamopsis tetragonoloba seeds, and derivatives and combinations thereof. Any thickening substance having similar physicochemical features to those listed above, which is not be interpreted as a limitation of the present disclosure, is also to be considered within the scope of the present disclosure. In a preferred embodiment of the present disclosure, the mixture comprises at least one thickening agent which is selected from the group consisting of natural or synthetic hydrophilic gums, galactomannans and their derivatives, guar gum and its derivatives, and mixtures thereof. In another preferred embodiment of the present disclosure, the at least one thickening agent comprises a galactomannan. In another preferred embodiment of the present disclosure, the at least one thickening agent comprises guar gum or its derivatives.

In a process according to an embodiment of the present disclosure, the insoluble fibers are selected from the group consisting of cellulose or hemicellulose fibers, resistant starch, powdered cellulose, refined powdered cellulose grade 30, 75, 90, 200 or 500 micrometers (for example, Unicell PF30, Unicell PF75, Unicell PF90, Unicell PF200, or Unicell PF500), microcrystalline cellulose, fiber from ground cereals, ground linseed, ground chia seeds, ground quinoa seeds, ground buckwheat seeds, wheat fiber, rice fiber, carrot fiber, citric fiber, potato fiber, corn fiber, banana fiber, blueberry fiber, apple fiber, bamboo fiber, coconut fiber, sugar cane fiber, oat fiber, pea fiber, and derivatives and combinations thereof. Any insoluble fiber having similar physicochemical features to those listed above, which is not be interpreted as a limitation of the present disclosure, is also to be considered within the scope of the present disclosure. In a preferred embodiment according to the present disclosure, the insoluble fibers comprise cellulose fibers. In another preferred embodiment according to the present disclosure, the insoluble fibers comprise powdered cellulose. In yet another preferred embodiment according to the present disclosure, the insoluble fibers comprise refined powdered cellulose, for example, refined powdered cellulose grade 200.

In a process according to an embodiment of the present disclosure, the flour made from one or more cereals and/or pseudocereals is selected from the group consisting of rice flour, oat flour, barley flour, rye flour, corn flour, millet flour, wheat flour, sorghum flour, spelt flour, amaranth (kiwicha, huautli, Amaranthus hypochondriacus, celosia) flour, quinoa flour, chia (chan) flour, breadnut (Brosimum alicastrum) flour, buckwheat flour, cattail (typha) flour, canihua (kañiwa) flour, acacia flour, huauzontle (Chenopodium berlandieri) flour and combinations thereof. Flours from seeds and grains not listed above, which is not be interpreted as a limitation of the present disclosure, are also to be considered within the scope of the present disclosure. In an embodiment according to the present disclosure, the flour made from one or more cereals and/or pseudocereals is a gluten-free flour or a flour free of wheat, oats, barley and rye. In a preferred embodiment according to the present disclosure, the flour made from one or more cereals and/or pseudocereals comprises rice flour.

In a process according to an embodiment of the present disclosure, the mixture may comprise:
a flour made from one or more cereals and/or pseudocereals, for example, a gluten-free flour or a flour free of wheat, oats, barley and rye, for example, rice flour;
at least one thickening agent selected from natural or synthetic hydrophilic gums, galactomannans and their derivatives, guar gum and its derivatives, and mixtures thereof;
insoluble fibers comprising cellulose fibers, for example, powdered cellulose, for example, refined powdered cellulose, for example, refined powdered cellulose grade 200; and
an aqueous liquid, for example, water

In a process according to an embodiment of the present disclosure, the mixture comprises up to about 90% by weight of flour made from one or more cereals and/or pseudocereals. In another embodiment, the mixture comprises from about 5% to about 90% by weight of flour made from one or more cereals and/or pseudocereals. In yet another embodiment, the mixture may comprise from about 10% to about 80% by weight, or from about 20% to about 70% by weight of flour made from one or more cereals and/or pseudocereals. In a preferred embodiment of a process according to the present disclosure, the mixture comprises from about 20% by weight to about 60% by weight of flour made from one or more cereals and/or pseudocereals, or from about 30% to about 50% by weight of flour made from one or more cereals and/or pseudocereals. For example, in an embodiment of a process according to the present disclosure, the mixture comprises from about 20% by weight to about 60% by weight, or from about 30% to about 50% by weight of a gluten-free flour or a flour free of wheat, oats, barley and rye, for example, rice flour.

In a process according to an embodiment of the present disclosure, the mixture comprises up to about 55% by weight of insoluble fibers, up to about 45% by weight of insoluble fibers, up to about 35% by weight of insoluble fibers, up to about 25% by weight of insoluble fibers, or up to about 15% by weight of insoluble fibers. In another embodiment according to the present disclosure, the mixture may comprise from about 1% by weight to about 45% by weight of insoluble fibers, or from about 1% by weight to about 30% by weight of insoluble fibers. In a preferred embodiment according to the present disclosure, the mixture may comprise from about 1% by weight to about 20% by weight of insoluble fibers, or from about 5% by weight to about 15% by weight of insoluble fibers. For example, in an embodiment of a process according to the present disclosure, the mixture may comprise from about 1% by weight to about 20% by weight of cellulose fibers, or from about 5% by weight to about 15% by weight of cellulose fibers. For example, in another embodiment of a process according to the present disclosure, the mixture may comprise from about 1% by weight to about 20% by weight, or from about 5% by weight to about 15% by weight of powdered cellulose, for example, refined powdered cellulose, for example, refined powdered cellulose grade 200.

In a process according to an embodiment of the present disclosure, the mixture comprises up to about 20% by weight, or up to about 10% by weight, or up to about 5% by weight of at least one thickening agent. In a preferred embodiment, the mixture may comprise up to about 2% by weight, or up to about 1% by weight of at least one thickening agent. For example, in an embodiment of the present disclosure, the mixture comprises up to about 2% by weight or up to about 1% by weight of a thickening agent comprising a natural or synthetic hydrophilic gum, or of a thickening agent comprising a galactomannan, for example, guar gum or its derivatives.

In a process according to an embodiment of the present disclosure, the mixture comprises an aqueous liquid which may comprise water or any aqueous solution, suspension or emulsion. For example, the mixture according to an embodiment of the present disclosure may comprise water, milk, a saline solution, or plant-based liquids and beverages such as rice, coconut, barley, almond, oats, soybean, hazelnut, millet or peanut milk, among others. The amount of aqueous liquid will depend on the amount of the other components. This means that the aqueous liquid will be added to the mixture as needed to reach 100%. In a process according to an embodiment of the present disclosure, the mixture comprises up to about 90% by weight of aqueous liquid. In another embodiment, the mixture may comprise up to about 80% by weight of aqueous liquid, up to about 70% by weight of aqueous liquid, up to about 60% by weight of aqueous liquid, or up to about 50% by weight of aqueous liquid. In a preferred embodiment, the mixture may comprise from about 20% to about 80% by weight of aqueous liquid, or from about 30% to about 70% by weight of aqueous liquid. For example, the mixture may comprise from about 20% to about 80% by weight, or from about 30% to about 70% by weight of water.

In a process according to an embodiment of the present disclosure, the mixture may comprise:
from about 20% by weight to about 60% by weight of flour made from one or more cereals and/or pseudocereals, or from about 30% to about 50% by weight of flour made from one or more cereals and/or pseudocereals, for example, a gluten-free flour or a flour free of wheat, oats, barley and rye, for example, rice flour;
up to about 2% by weight, or up to about 1% by weight of at least one thickening agent selected from natural or synthetic hydrophilic gums, galactomannans and their derivatives, guar gum and its derivatives, and mixtures thereof;
from about 1% by weight to about 20% by weight, or from about 5% by weight to about 15% by weight of insoluble fibers comprising cellulose fibers, for example, powdered cellulose, for example, refined powdered cellulose, for example, refined powdered cellulose grade 200; and
from about 20% to about 80% by weight, or from about 30% to about 70% by weight of an aqueous liquid, for example, water.

For example, the mixture in a process according to an embodiment of the present disclosure comprises, for every 100 g of mixture, from 40.00 g to 46.00 g of rice flour, from 9.00 g to 12.00 g of cellulose fiber, for example, powdered cellulose, for example, refined powdered cellulose, for example, refined powdered cellulose grade 200; from 0.4 g to 0.6 g of guar gum; and an amount of water that is enough to complete 100 g of mixture.

In a process according to an embodiment of the present disclosure, the mixture may optionally comprise one or more preservatives. The one or more preservatives according to an embodiment of the present disclosure may comprise sorbic acid or its sodium, potassium or calcium salts; sodium, potassium or calcium acetate; lactic acid or its sodium, potassium or calcium salts; sodium, potassium or calcium propionate; ascorbic acid or its sodium, potassium or calcium salts; tocopherols; lecithin; citric acid or its sodium, potassium or calcium salts; tartaric acid or its sodium or potassium salts; or mixtures thereof or any other preservative.

In a process according to an embodiment of the present disclosure, the mixture may optionally comprise one or more coloring agents. The one or more optional coloring agents according to an embodiment of the present disclosure may comprise curcumin phosphate (yellow), lactoflavin (yellow), lactoflavin phosphate (yellow), carotenoids (yellow, orange and red), xanthophylls (orange), betanin (red), anthocyanins (blue, violet or red) or mixtures thereof, or any other coloring agent.

In a process according to an embodiment of the present disclosure, the mixture is a mixture free of gluten or free of wheat, oats, barley and rye.

In a process according to an embodiment of the present disclosure, the mixture may be a liquid or semi liquid mixture, a semisolid mixture, a thick mixture relatively soft and relatively firm, for example, a kneadable mixture or dough or an injectable mixture or dough, preferably a homogeneous mixture or dough free of lumps.

In a process according to an embodiment of the present disclosure, cooking may be carried out at a temperature of up to about 400° C. In another embodiment according to the present disclosure, cooking is carried out at a temperature from about 80° C. to about 400° C. In another embodiment according to the present disclosure, cooking is carried out at a temperature from about 100° C. to about 300° C., for example, about 200° C. However, the cooking temperature may be higher or lower depending on the cooking time and the kind of article to be manufactured.

The process according to an embodiment of the present disclosure may be carried out in any kind of mold. For example, a mold to carry out a process according to an embodiment of the present disclosure comprises two pieces, each of which comprises an inner surface, where the inner surface of at least one of said two mold pieces comprises at least one hollow portion, so that when faced to each other and placed in contact said inner surfaces of said two mold pieces form a cavity capable of containing the mixture.

In a process according to an embodiment of the present disclosure, it is expected that vapor will be generated within the mold, causing internal pressure. In a process according to an embodiment of the present disclosure, the pressure generated within the mold during cooking of the mixture is released by separating the mold pieces for an instant, thus releasing the vapor generated inside the mold, which may optionally be released through ventilation. In another embodiment, the mold may comprise one or more openings that can open and close during cooking to release pressure and to remove the vapor generated inside the mold.

In a process according to an embodiment of the present disclosure, the pressure generated within the mold is released one or more times. In another embodiment, the pressure may be released two or more times. In yet another embodiment, the pressure generated within the mold during cooking may be released intermittently during a specified time period, the duration of which will depend on the cooking temperature and the kind of product to be manufactured.

In an embodiment according to the present disclosure, the pressure generated within the mold is released intermittently to remove the generated vapor for a period selected from about 20 minutes, up to about 15 minutes, up to about 10 minutes, up to about 5 minutes, or up to about 3 minutes. In another embodiment, the pressure generated within the mold may be released intermittently for a period of about 1 minute.

Similarly, the number of pressure release intervals will depend on the cooking temperature and the kind of product to be manufactured. In a process according to an embodiment of the present disclosure, pressure may be released once every approximately 1 second to approximately 30 seconds. For example, pressure may be released once every approximately 30 seconds, once every approximately 20 seconds, once every approximately 10 seconds, once every approximately 5 seconds, once every approximately 3 seconds or once every approximately 1 second. For example, in a process according to an embodiment of the present disclosure the pressure may be released once every approximately 1 to approximately 3 seconds for a period of about up to 5 minutes, up to approximately 3 minutes, for example, approximately 1 minute.

In a process according to an embodiment of the present disclosure, cooking comprises two stages, a first stage where the pressure generated within the mold is released intermittently to remove the generated vapor, and a second stage where the mold remains closed to finish cooking. In an embodiment according to the present disclosure, the first cooking stage where the pressure generated within the mold is released intermittently to remove the generated vapor has a duration of up to about 20, up to about 15 minutes, up to about 10 minutes, up to about 5 minutes, or up to about 3 minutes, for example, about 1 minute. In an embodiment according to the present disclosure, the second cooking stage has a duration of up to about 45 minutes, up to about 30 minutes, up to about 15 minutes, up to about 10 minutes, or up to about 5 minutes. For example, the second cooking stage may have a duration of about 5 minutes.

In a process according to an embodiment of the present disclosure, the mixture may be placed into the mold manually or through an automated or semi-automated mechanism. For example, in an embodiment, the mixture may be put into the mold through an injection mechanism where the mold may be open or closed, where in the latter case there may be an opening in the mold for that purpose.

In an embodiment, the mold may comprise two pieces, bottom and top, each of which comprises an inner surface, where the inner surface of at least one of said two mold pieces comprises at least one hollow portion, so that when faced to each other and placed in contact said inner surfaces of said two mold pieces form a cavity where the mixture may be contained. In this case, the mixture may be placed into the inner surface of the bottom mold piece.

In a process according to an embodiment of the present disclosure, the mixture is a kneadable mixture or dough. In an embodiment, the ingredients of the mixture may be previously combined in a mixer or may be manually mixed to obtain a kneadable mixture. For example, the dough may be prepared charging, mixing and kneading the ingredients of the mixture in a kneader. In an embodiment, the ingredients of the mixture may be charged into an extruder and mixed by extrusion to obtain the kneadable mixture.

The extruders may comprise a feed funnel and the ingredients may be mixed while they are pushed by a screw towards an exit through one or more nozzles. In an embodiment, the nozzle of an extruder may be approached to an opening in the mold to fill the cavities, injecting the mixture in a controlled manner into a closed or open mold.

In an embodiment, the mixture may be a kneadable mixture and the preparation of the dough may comprise an intermediate stage consisting in sheeting the dough, which can be then cut in portions of a suitable size for the selected mold. For example, in an embodiment, the dough may be sheeted by passing it between rollers. The sheeted dough may then be placed into a mold comprising cavities that match the shape of the articles to be manufactured, where the cavities may be placed side by side. For example, the sheeted dough may be put on the inner surface of the bottom mold piece comprising also a top piece, where at least one of said top and bottom pieces comprises at least one hollow portion, so that, when placed in contact, the inner surface of the bottom mold piece and the inner surface of the top piece of the mold form a cavity that contains a portion of the sheeted dough. In an embodiment, the mold may form more than one cavity and as a result a sheet of die-cut articles may be obtained. In an embodiment, the die-cut articles of the sheet may be separated manually or mechanically, for example, placing the sheet inside a vibrating chamber. In an embodiment, the manual separation of the articles may be carried out in pairs or individually. In a preferred embodiment, the articles may present the least possible burr to avoid expensive finishing steps.

In a process according to an embodiment of the present disclosure, the manufactured articles may be removed from the mold manually or through an automated or semi-automated process. For example, releasing the articles from the mold may be carried out by turning the mold around so that the manufactured articles fall by gravity. In an embodiment, the articles may be dropped into a receptacle, on a tray or over a conveyor belt.

In a process according to an embodiment of the present disclosure, the manufactured articles may be cooled down before or after their release, and said cooling may be carried out by exposing the articles to room temperature and/or by forced ventilation.

In a process according to an embodiment of the present disclosure, the cooking process may be carried out by applying heat to the mold placed inside a stationary or continuous oven, heated by gas combustion, by hot vapor circulation exchange or by electrical resistance. In another embodiment, cooking may be carried out in a device comprising a mold and heating means to heat said mold.

In a second aspect, the present disclosure is directed to an edible and/or biodegradable article manufactured by the process of the present disclosure. The edible and/or biodegradable article manufactured by the process according to an embodiment of the present disclosure may be a kitchen utensil, eating and/or household article or utensil, for example, knives, forks, spoons, stirrers, chopsticks, skewers, rods, straws, popsicle sticks, cones, ice cream cornets, packaging and containers of all kinds with or without a lid such as cups, mugs, demitasses, plates, dessert bowls, trays, bowls, salad bowls, and the like. In another embodiment, the edible and/or biodegradable article may be a sports article, for example, a golf tee.

A process according to an embodiment of the present disclosure may be carried out for manufacturing an edible and/or biodegradable article of any kind. In an embodiment, the edible and/or biodegradable article manufactured by the process according to an embodiment of the present disclosure may comprise a kitchen, tableware and/or household article or utensil. For example, the edible and/or biodegradable article manufactured by the process according to an embodiment of the present disclosure may comprise knives, forks, spoons, stirrers, chopsticks, skewers, rods, straws, popsicle sticks, cones, ice cream cornets, packaging and containers of all kinds with or without a lid such as cups, mugs, demitasses, plates, dessert bowls, trays, bowls, salad bowls, and the like. In another embodiment, the article manufactured by the process according to an embodiment of the present disclosure may comprise a sports article, for example, a golf tee.

In an embodiment, the edible and/or biodegradable articles manufactured by a process according to an embodiment of the present disclosure have a suitable hardness for preventing them from breaking easily when used. This feature is beneficial because it allows the article to be used for a wide variety of applications for which more fragile articles are not suitable. In addition, the edible and/or biodegradable articles are generally intended for a single use, and this reduces the probability of the articles to break before the end of their first, and probably only, use. For example, for edible and/or biodegradable articles such as knives, forks, chopsticks, etc. it is particularly beneficial to be more resistant to breakage.

In an embodiment, the edible and/or biodegradable articles manufactured by a process according to an embodiment of the present disclosure are less sensitive to softening from contact with liquid or semi liquid substances or those comprising a considerable amount of water. This feature is particularly beneficial for articles intended to contain liquids (for example, cups, mugs, etc.) and also for articles intended to be in contact with liquids (spoons, stirrers, chopsticks, etc.), although it is also beneficial for articles not intended to be immersed in liquids that might contact liquids during their use (for example, knives, forks, etc.). It is also a beneficial feature for articles intended to hold ice-creams.

In a third aspect, the present disclosure relates to a device for manufacturing edible and/or biodegradable articles comprising:
a lower support element and an upper support element, where the lower support element comprises a bottom mold piece and where the upper support element comprises a top mold piece, where each of said pieces of said mold comprises an inner surface, where the inner surface of at least one of the two mold pieces comprises at least one hollow portion, so that, when faced to each other and placed in contact, said inner surfaces of said two mold pieces form at least one cavity capable of containing a mixture of ingredients of the edible and/or biodegradable article to be manufactured; where the mold pieces are capable of withstanding cooking temperatures;
a frame structure serving as a support base, stand or rack for the other parts of the device,
being said bottom and upper support elements placed so that at least one of said bottom or upper support elements can be moved, allowing the inner surfaces of the mold pieces to approach or move away from each other, so that the mold may change from an open position to a closed position and vice versa; where, in said closed position, the inner surfaces of the mold pieces are facing each other and in contact to form said at least one cavity; and where, in said open position, the inner surfaces of the mold pieces are separated opening said cavity;
mechanical means to move at least one of said top or bottom support elements; and
heating means to heat the mold pieces.

In a device according to an embodiment of the present disclosure, the frame structure may be any structure capable of serving as support base, stand or rack for the other parts of the device. In an embodiment according to the present disclosure, the frame structure may comprise at least one guide along which at least one of said top or bottom support elements may move vertically. For example, in an embodiment, the lower support element may remain stationary relative to said frame structure and the upper support element may move, allowing the inner surfaces of the mold pieces to approach or move away from each other, or vice versa. In an embodiment, the lower support element may remain stationary while the upper support element may move vertically along the guide, or vice versa. In another embodiment, the upper and lower support elements may get closer or further by means of a non-vertical movement, for example, by means of a hinge-like movement where the upper and lower support elements remain joined at one of their sides while the opposite sides are separated.

A device according to an embodiment of the present disclosure comprises mechanical means to move at least one of said upper and lower support elements. In an embodiment, the mechanical means may comprise a servomotor or pneumatic actuator that moves at least one of said top or bottom support elements. For example, in an embodiment, the mechanical means may comprise a servomotor or pneumatic actuator that moves at least one of said top or bottom support elements vertically, for example, along a guide or axis in the frame structure.

In a device according to an embodiment of the present disclosure, the heating means to heat the mold pieces may comprise heat exchangers that circulate hot gasses from gas combustion, coils that circulate hot vapor, electrical resistors or a combination thereof. However, any heat source capable of reaching the desired cooking temperature may be used. In a preferred embodiment, the heating means comprise electrical resistors. In an embodiment, the heating means may be included in the upper and lower support elements, in contact with the mold pieces. In another embodiment, the device may comprise top and bottom heating elements including said heating means, where the top and bottom heating elements may be coupled or mounted on the upper and lower support elements, respectively. For example, in an embodiment, the top and bottom heating means may be heating panels comprising electrical resistors. In an embodiment, the device may comprise at least one separating element between the upper and lower support elements and their respective heating elements, where said at least one separating element may function as a thermal insulator. In a device according to an embodiment of the present disclosure, thermal insulators, for example, pieces or panels of any insulating material, for example, Teflon, may be used as a separating element. The separating elements of a device according to the present disclosure may be useful to avoid the heat generated by the heating means to heat the mold pieces during cooking to transfer to the other parts of the device.

In a device according to an embodiment of the present disclosure, the support elements and/or the heating elements may be panels, for example, metal panels of a suitable thickness or a piece made of metal or any other material that is suitable for the task.

The mold pieces in a device according to an embodiment of the present disclosure may be included in the top and bottom heating elements comprising said heating means, where said top and bottom heating elements may be coupled or mounted on said upper and lower support elements, respectively.

Thus, in a device according to an embodiment of the present disclosure, the upper and lower support elements may be coupled to the respective top and bottom heating elements comprising heating means, being the heating means optionally separated from the respective support elements by insulating separating elements, where the top and bottom mold pieces are coupled to the respective top and bottom heating elements, so that, when the mechanical means move a support element, they produce a movement of the whole set comprised of the support element, the heating element, the separating element and the mold piece.

The mold pieces of a device according to an embodiment of the present disclosure comprise an inner surface, where the inner surface of at least one of the two mold pieces comprises at least one hollow portion, so that, when faced to each other and placed in contact, said inner surfaces of said two mold pieces form at least one cavity capable of containing a mixture of ingredients of the edible and/or biodegradable article to be manufactured. However, the shape of the inner surfaces of the mold pieces may vary depending on the shape of the article to be manufactured. In an embodiment, the inner surfaces of the two mold pieces, when faced to each other and placed in contact, form more than one cavity, so that more than one article may be prepared at the same time. In an embodiment, the cavities are placed in an arrangement that covers the maximum possible area, minimizing dead space that might lead to low production yields or material waste.

In a preferred embodiment, the mold pieces may comprise detachable pieces or dies, allowing the same device to be used for different articles employing dies of different shapes. In an embodiment, the detachable pieces of the mold may be mounted on the upper and lower support elements, or in the case of devices comprising heating elements, on the top and bottom heating elements. In an embodiment, the device may comprise fastening means to fix the mold in its closed position.

A device according to an embodiment of the present disclosure may comprise at least one temperature sensor. In an embodiment, the at least one temperature sensor may be associated to at least one of the mold pieces, and/or to at least one of the heating elements, and/or to at least one of the support elements. In an embodiment, the at least one temperature sensor may be optionally connected to a thermostat and/or to a control element, for example, to a PLC.

A device according to an embodiment of the present disclosure may comprise a mechanism to release the manufactured edible and/or biodegradable articles. In an embodiment, the mechanism to release the manufactured edible and/or biodegradable articles may operate, for example, by tilting the bottom mold piece so that the manufactured edible and/or biodegradable articles fall by gravity. For example, in an embodiment, the device may comprise a release mechanism consisting of an axis on which the lower support element is mounted, rolling bearings mounted on the frame structure on which said axis is installed and, optionally, a servomotor or pneumatic actuator capable of lifting the lower support element from one of its sides.

A device according to an embodiment of the present disclosure may comprise a mold filling mechanism to add the mixture of ingredients of the edible and/or biodegradable article to be manufactured. In an embodiment, the mold filling mechanism may comprise an injection device, for example, a dough injection device. In an embodiment, the filling mechanism may comprise a manual, automated or semi-automated device. In an embodiment, the mold filling mechanism may comprise a cylinder or cartridge where the mixture is contained prior to injection by means of a pneumatic actuator or servomotor, and one or more dispensing nozzles. In an embodiment, the injection of the mixture towards the one or more dispensing nozzles to fill the one or more cavities of the mold may be controlled by a control element or by an operator. Mold filling into a device according to an embodiment of the present disclosure may be carried out while the mold is open, i.e. when the inner surfaces of the mold are separated, or when the mold is closed, in which case the mold may comprise at least one opening intended for this purpose. The mold filling mechanism of a device according to an embodiment of the present disclosure may be part of the device or may comprise an accessory mechanism separated from the device.

A device according to an embodiment of the present disclosure may be manual, automatic or semi-automatic. A device according to an embodiment of the present disclosure may comprise one or more control elements to control the temperature of the mold pieces, the movement of the at least one support element, the release mechanism of the manufactured articles, and/or the mold filling mechanism. The control element(s) of a device according to an embodiment of the present disclosure may comprise a Programmable Logic Controller (PLC), a Computer Numerical Control (CNC), a mini-controller, a micro-controller, a computer, a device with LOGO system, an Arduino device, or any other similar kind of programmable controller. The control element(s) of a device according to an embodiment of the present disclosure may be optionally associated to a timer. The control element(s) of a device according to an embodiment of the present disclosure may be programmable with pre-established instructions to control the temperature of the mold pieces, the movement of the at least one support element, the mechanism to release the manufactured edible and/or biodegradable articles, and/or the mold filling mechanism, as well as the duration of each action. For example, the control element(s) of a device according to an embodiment of the present disclosure may be associated to the mechanical means, to the heating means, to the release mechanism and/or to the filling mechanism.

In an embodiment, two or more devices according to the present disclosure may be placed side by side, forming a production line, and a conveyor belt may be used to receive the manufactured products. In an embodiment, one or more accessory filling mechanisms according to the present disclosure may be used to fill the devices placed side by side, where said filling mechanism may be automated, semi-automated or may be manually operated by a user.

A device according to an embodiment of the present disclosure may be used to carry out the processes for manufacturing edible and/or biodegradable articles according to the present disclosure. For example, a device according to an embodiment of the present disclosure may be used to carry out a process comprising pouring a mixture in the hollow portion of a mold piece and cooking the mixture in the closed mold, where said heating means may be used to raise the temperature of the mold pieces, where the pressure generated within the closed mold is released one or more times during cooking to allow exhaust of the vapor generated inside the mold, where the pressure generated within the mold may be released by separating the mold pieces, for example, by the vertical movement of the upper support element.

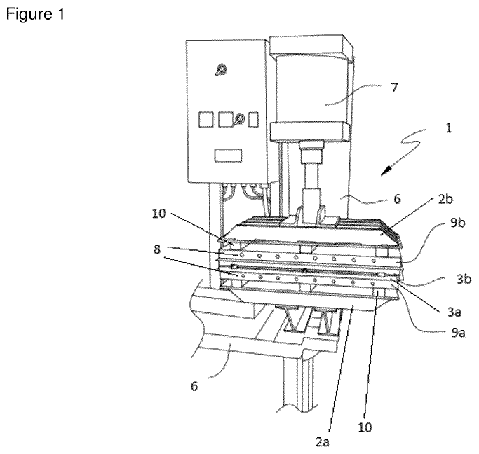

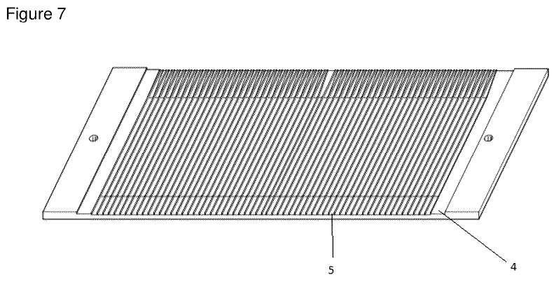

Detailed reference is made below to the figures describing exemplary particular embodiments according to the present disclosure. FIGS. 1 to 6 depict devices according to particular embodiments of the present disclosure, while FIG. 7 shows an example of a mold piece to be used in a device according to an embodiment of the present disclosure. As shown in FIGS. 1 to 7, a device (1) for manufacturing edible and/or biodegradable articles according to an embodiment of the present disclosure comprises a lower support element (2a) and an upper support element (2b), where the lower support element comprises a bottom mold piece (3a) and where the upper support element comprises a top mold piece (3b), where each of said pieces of said mold comprises an inner surface (4), where the inner surface of at least one of the two mold pieces comprises at least one hollow portion (5), so that, when faced to each other and placed in contact, said inner surfaces of said two mold pieces form at least one cavity capable of containing a mixture of ingredients of the edible and/or biodegradable article to be manufactured; where the mold pieces (3a, 3b) are capable of withstanding cooking temperatures;
a frame structure (6) serving as a support base, stand or rack for the other parts of the device,
where said lower (2a) and upper (2b) support elements are placed so that at least one of said lower (2a) or upper (2b) support elements can be moved, allowing the inner surfaces of the mold pieces (3a, 3b) to approach or move away from each other, so that the mold may change from an open position to a closed position and vice versa; where, in said closed position, the inner surfaces of the mold pieces (3a, 3b) are facing each other and in contact to form said at least one cavity; and where, in said open position, the inner surfaces of the mold pieces (3a, 3b) are separated, opening said cavity;
mechanical means (7) to move at least one of said lower or upper support elements (2a, 2b); and
heating means (8), for example, electrical resistors, to heat the mold pieces (3a, 3b).

As shown in FIGS. 1 to 6, in a device according to an embodiment of the present disclosure the bottom (3a) and top (3b) mold pieces may be mounted on bottom (9a) and top (9b) heating elements, where said heating elements (9a, 9b) may comprise said heating means (8), where said bottom and top heating elements (9a, 9b) may be mounted on said bottom and upper support elements (2a, 2b), respectively.

Also, as shown in FIGS. 1 to 6, a device according to an embodiment of the present disclosure may comprise at least one separating element (10) between the lower and upper support elements (2a, 2b) and their respective heating elements (9a, 9b), where said at least one separating element may act as a thermal insulator.

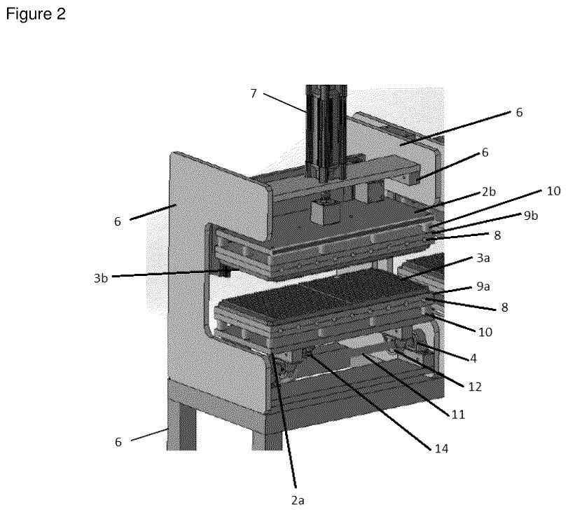

Also, as shown in FIGS. 2 to 6, a device according to an embodiment of the present disclosure may comprise a mechanism to release the manufactured edible and/or biodegradable articles that may operate by tilting the mold piece bottom (3a) so that the manufactured edible and/or biodegradable articles fall by gravity. In a device according to an embodiment of the present disclosure, the release mechanism may comprise an axis (11) on which the lower support element is mounted (2a), rolling bearings (12), which may be comprised in rolling bearing housings (13), mounted on the frame structure (6) on which said axis is installed (11) and an actuator or servomotor (14) that lifts the lower support element (2a) from one of its sides.

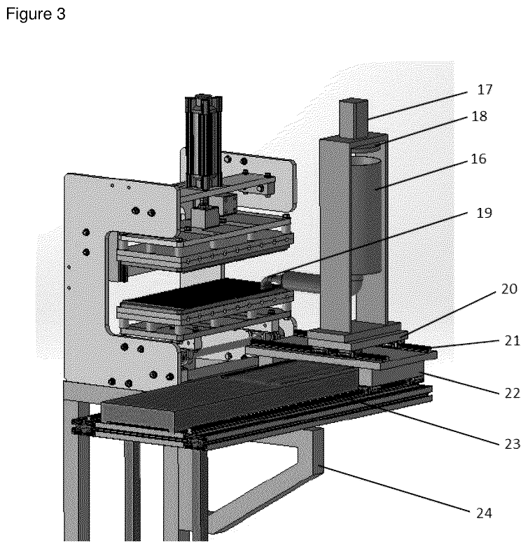

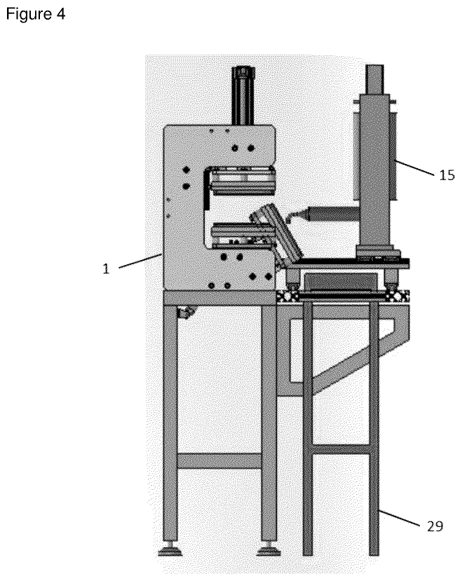

Also, as shown in FIGS. 3 and 4, a device according to an embodiment of the present disclosure may comprise a mold filling mechanism (15) to fill the mold with the mixture of ingredients of the edible and/or biodegradable article to be manufactured. In an embodiment, the mold filling mechanism (15) comprises an injection device. In an embodiment, the mold filling mechanism (15) may comprise a cylinder or cartridge (16) where the mixture is contained prior to injection by means of a pneumatic actuator or servomotor (17), an injection piston (18) and one or more dispensing nozzles (19). The mold filling mechanism (15) of a device according to an embodiment of the present disclosure may be part of the device or may comprise an accessory mechanism separated from the device. For example, the mold filling mechanism (15) may be placed on a forward-displacing carriage (20) which may comprise forward-displacing rails (21), where the forward-displacing carriage (20) may be placed on a transverse-displacing carriage (22) that may move along transverse-displacement rails (23), all supported by a structure comprising a frame (24). This arrangement of the mold filling mechanism (15) allows the mold filling mechanism (15) to move in both directions relative to the device in order to aim the one or more nozzles (20) to different parts of the mold. Similar structures that allow this movement in both directions of the mold filling mechanism may be designed to be used for this purpose. The forward and/or transverse displacement of the filling mechanism may be automated or controlled by an operator (25).

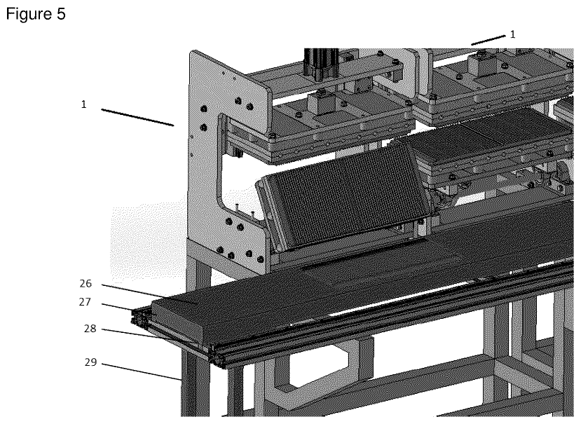

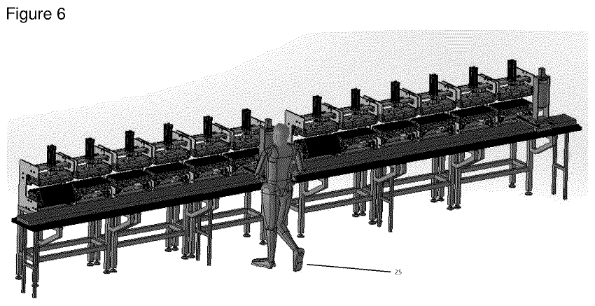

Also, as shown in FIGS. 5 and 6, in an embodiment, two or more devices (1) according to the present disclosure may be placed side by side generating a production line, and a conveyor belt (26) may be placed in order to carry the manufactured products. The conveyor belt may comprise a roller (27) and a transmission motor (28) and may be supported by a frame or support structure (29).

Also, as shown in FIG. 7, the inner surfaces (4) of the mold pieces (3a, 3b), may comprise more than one hollow portion (5) so that, when faced to each other and placed in contact, they form more than one cavity, allowing the manufacture of more than one article each time.

### EXAMPLES

### Example 1

Two chopstick sets were manufactured, and their breaking strength and resistance to softening in liquids were compared as described below.

A chopstick group named Group A was manufactured by the following process:
A dough comprising a mixture of rice flour (43.2 grams every 100 grams of dough), 10.3 grams of refined powdered cellulose grade 200 (Unicell® PF 200) per 100 grams of dough, 0.5 g of guar gum (Procol® U Special) per 100 grams of dough and an amount of water that is enough to complete 100 grams of dough (about 45.9 g per 100 grams of dough) was prepared;
The resulting dough was cooked at a temperature of about 200° C. following a cooking protocol consisting of a first stage during which the mold was opened intermittently every 1 to 3 seconds for a period of about 1 minute to release the vapor generated by cooking, and a second stage during which the mold was closed for a period of about 5 minutes.

On the other hand, a group of chopsticks named Group B were manufactured using a mixture of 50% by weight rice flour, 14% by weight oat fiber, 1% by weight rice protein and 35% by weight water.

### Example 2

The breaking strength of each of the chopstick groups was tested by lifting weights with their ends.

Chopsticks from group A exhibited a significantly higher strength than chopsticks from group B.

In particular, it was possible to lift a weight of about 1.7 kg using a chopstick of group A, while chopsticks of group B broke when attempting to lift a weight of 0.5 kg.

### Example 3

Softening caused by contact with liquids was tested by submerging the chopsticks in cold and hot liquids.

Chopsticks of group A exhibited a significantly higher resistance to softening caused by contact with liquids than chopsticks of group B.

In particular, chopsticks of group B softened considerably after 30 seconds in cold soybean sauce, while chopsticks of group A exhibited no softening even after 2 minutes in hot water.

What is claimed is:

1. A process for manufacturing edible and/or biodegradable articles, comprising:
providing a mixture comprising from about 20% by weight to about 60% by weight of rice flour, up to about 2% by weight of at least one thickening agent selected from the group consisting of guar gum and derivatives of guar gum, from about 1% by weight to about 20% by weight of refined powdered cellulose, and from about 20% to about 80% by weight of water;
placing the mixture in a mold; and
cooking the mixture in the mold when the mold is closed, wherein pressure generated within the closed mold is released one or more times during said cooking to allow exhaust of a vapor generated inside the mold, wherein said cooking comprises two stages, a first stage where the pressure generated within the mold is released intermittently to remove the generated vapor, and a second stage where the mold remains closed to finish cooking;
wherein the mold comprises two pieces, each of the two pieces comprising an inner surface, wherein the inner surface of at least one of said two mold pieces comprises at least one hollow portion, so that when faced to each other and placed in contact said inner surfaces of said two mold pieces form a cavity where the mixture is poured;
wherein the pressure generated within the mold during said cooking is released by separating the mold pieces;
wherein said cooking is carried out at a temperature from about 80° C. to about 400° C.

2. The process according to claim 1, wherein a grade of the refined powdered cellulose is 30, 75, 90, 200, or 500 micrometers.

3. The process according to claim 1, wherein a grade of the refined powdered cellulose is 200 micrometers.

4. The process according to claim 1, wherein the at least one thickening agent is guar gum.

5. The process according to claim 1, wherein the mixture comprises:
from about 30% to about 50% by weight of the rice flour;
up to about 1% by weight of said at least one thickening agent;
from about 5% by weight to about 15% by weight of the refined powdered cellulose; and
from about 30% to about 70% by weight of the water.

6. The process according to claim 1, wherein said first stage has a duration of up to about 5 minutes, and said second stage has a duration of up to about 15 minutes.

7. The process according to claim 6, wherein the pressure generated within the mold is released once every approximately 1 to approximately 3 seconds.
